(19) United States
(12) Patent Application Publication
(10) Pub. No.: US 2005/0250043 A1
(43) Pub. Date: Nov. 10, 2005

(54) Method of making a photopolymer sleeve blank for flexographic printing

(76) Inventors: Michael E. McLean, Etowah, NC (US); Dieter Schulze-Baing, Ahaus-Ottenstein (DE); Michael Kockentiedt, Legden (DE); Will Goss, Arden, NC (US)

Correspondence Address: DINSMORE & SHOHL LLP;One Dayton Centre, Suite 500, One South Main Street, Dayton, OH, 45402-2023, US

(21) Appl. No.: 11/124,427

(22) Filed: May 6, 2005

Related U.S. Application Data
(60) Provisional application No. 60/568,979, filed on May 7, 2004.

(51) Int. Cl. G03C 1/76

(52) U.S. Cl. 430/270.1

(57) ABSTRACT

A method of making a photopolymer sleeve blank is provided which includes providing a base sleeve, applying a cushion layer over the base sleeve, and applying a first photopolymer layer over the cushion layer. The exterior-facing surface of the first photopolymer layer is exposed to a curing source, followed by the application of a second, uncured photopolymer layer over the first photopolymer layer. The first photopolymer layer is preferably ground to a predetermined thickness either before or after exposure to the curing source to provide a preferred floor dimension. The resulting photopolymer sleeve blank has a uniform floor which can be readily imaged and processed by conventional equipment used in the flexographic printing industry.

### CROSS REFERENCE TO RELATED APPLICATIONS

This application claims the benefit of U.S. Provisional Application No. 60/568,979, entitled METHOD OF MAKING A PHOTOPOLYMER SLEEVE BLANK FOR FLEXOGRAPHIC PRINTING, filed May 7, 2004. The entire contents of said application are hereby incorporated by reference.

### BACKGROUND OF THE INVENTION

The present invention relates to a method of making a photopolymer sleeve blank, and more particularly, to an improved method of making a photopolymer sleeve blank for use in flexographic printing applications which may be imaged by an end user.

Flexographic printing plates formed from photopolymerizable compositions are well known for use in printing applications. Such photopolymerizable compositions typically comprise at least an elastomeric binder, a monomer, and a photoinitiator. Upon exposure of the photopolymer plate from the back to actinic radiation, polymerization of the photopolymerizable layer occurs. This step is typically referred to as an initial “back exposure” step in which the polymerized portion of the cross-section of the printing plate is formed, which is referred to as the “floor.” The floor provides a foundation for the creation of a relief image on the plate. After the desired image of the printing plate is formed above the floor, the unexposed areas of the plate are removed, typically by washing with a solvent, to form a printing relief. However, when using individually attached plates in which the plates are wrapped around a print cylinder or print sleeve, a seam or void interrupts the image, causing a disruption or distortion in the printed image which is transferred to the substrate.

In more recent years, “seamless” hollow cylindrical sleeves have been developed which include a photopolymer layer as a support for various types of printing. For example, in one existing printing process and product (commercially available from OEC Graphics, Inc. under the designation SEAMEX®), a photopolymerizable material in the form of a flat sheet is wrapped around a metal or plastic sleeve and heated to fuse the ends and bond the photopolymerizable material to the sleeve. The photopolymerizable material is subjected to a back exposure step prior to wrapping the sleeve in order to achieve the required floor to support the details in the relief image. However, it is often desirable to product a seamless photopolymer surface including an underlying cushion layer such as a cushioning foam. While the above described process can include such a cushion layer, it is very time consuming and limits the production volume.

In order to achieve high volumes of seamless photopolymer sleeves, no “floor” can be present due to the creation of disturbances in the seam during fusing which occurs because the floor and the unexposed photopolymer above the floor fuse under different conditions.

It would be desirable to be able to produce high volumes of photopolymer sleeves which include an unexposed photopolymer layer over a cushion layer and which may be easily exposed to radiation to form the desired floor. It would also be desirable to produce a blank photopolymer sleeve which can be readily imaged by an end user to improve print quality.

Accordingly, there is still a need in the art for an improved method of making a photopolymer sleeve blank for use in flexographic printing operations.

### SUMMARY OF THE INVENTION

The present invention meets that need by providing an improved seamless photopolymer sleeve blank which is formed by providing first and second photopolymer layers, the first of which is exposed to radiation at the state of exposure typical to back exposed plate floors, and the second of which remains uncured, or “blank”. The resulting photopolymer sleeve blank has a uniform “floor”, and can be readily imaged and processed by conventional equipment used in the flexographic printing industry.

According to one aspect of the present invention, a method of making a photopolymer sleeve blank is provided comprising providing a base sleeve having an inner surface and an outer surface; applying a cushion layer over the outer surface of the base sleeve; applying a first photopolymer layer over the cushion layer; exposing an exterior-facing surface of the first photopolymer layer to a curing source; and applying a second photopolymer layer over the first photopolymer layer.

Preferably, the base sleeve comprises a fiber-reinforced polymeric resin. The base sleeve preferably has a wall thickness of from between about 0.01 and 6.35 mm, and more preferably, between about 0.60 and 0.80 mm.

The cushion layer preferably comprises a polymeric material selected from the group consisting of a closed cell foam, an open cell foam, or a volume displaceable material. The cushion layer preferably has a thickness from between about 0.25 mm and about 3.25 mm, and more preferably, between about 1.00 to about 1.50 mm. The cushion layer is preferably applied to the base sleeve by coating onto the surface of the base sleeve. Alternatively, the cushion layer may be applied to the base sleeve as a pre-cured layer which is wrapped around the sleeve.

Preferably, after the cushion layer is applied, the surface of the cushion layer is ground to achieve a predetermined thickness. Prior to applying the first photopolymer layer, an optional sealer or adhesive promoting agent may be applied to the surface of the cushion layer. The first photopolymer layer is then preferably laminated to the surface of the cushion layer. In one embodiment, the first photopolymer layer is fused to the surface of the cushion layer by the application of heat.

The first and second photopolymer layers preferably comprise a styrenic block copolymer-based material. The curing source used to expose the first photopolymer layer preferably comprises radiation. A preferred radiation curing source is a UV light source positioned exterior to the base sleeve. Preferably, the surface of the first photopolymer layer is ground to achieve a predetermined thickness either before or after exposure to the curing source, and more preferably, after exposure to radiation. This predetermined thickness provides the desired floor dimension. The first photopolymer layer preferably comprises from about 40% to about 80% of the total sleeve thickness after grinding.

The second photopolymer layer is then applied over the first photopolymer layer, and preferably laminated to it. In one embodiment, the second photopolymer layer is fused to the first photopolymer layer by the application of heat. After lamination, the second photopolymer layer is preferably ground to a predetermined thickness. The second photopolymer preferably comprises from about 20% to about 60% of the total sleeve thickness after grinding.

Preferably, the method of the present invention includes coating the second photopolymer layer with an ablatable coating. The ablatable coating functions to protect the second photopolymer layer from UV light, thus preventing curing of the layer prior to use. The resulting sleeve blank containing the second (uncured) photopolymer layer may be imaged and processed by conventional equipment used in the art.

Accordingly, it is a feature of the present invention to provide a photopolymer sleeve blank for use in flexographic printing applications which utilizes first and second photopolymer layers. Other features and advantages of the invention will be apparent from the following description, the accompanying drawings, and the appended claims.

### BRIEF DESCRIPTION OF THE DRAWINGS

FIG. 1 is a cross-sectional view of a photopolymer sleeve blank according to an embodiment of the present invention; and

FIG. 2 is a flow chart illustrating a method of making a photopolymer sleeve blank in accordance with an embodiment of the present invention.

### DETAILED DESCRIPTION OF THE PREFERRED EMBODIMENTS

Methods as practiced in embodiments of the present invention provide several advantages over prior art methods which utilize a “back exposure” step on photopolymer printing plates prior to assembly over a cushion layer. By grinding the first photopolymer layer to the desired floor dimension and exposing it to radiation from a position which is exterior to the base sleeve, also referred to as a “face” exposure step, a more uniform floor for the image is created. In addition, by providing a sleeve blank for use by an end user with a uniform floor, higher print quality results due to a more consistent relief depth. The methods as practiced also allow for improved dimensional control of the relief depth. Practice of embodiments of the invention are also more economical than prior methods as the products are manufactured directly on sleeves as opposed to manufacturing the product and then mounting it on a sleeve which results in seams on the product.

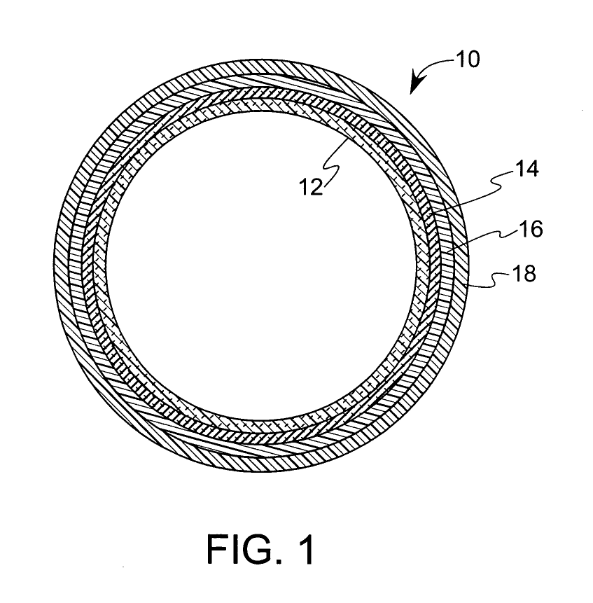

FIG. 1 illustrates one embodiment of the photopolymer sleeve blank 10 having a seamless surface which comprises a base sleeve 12, a cushion layer 14, and first and second photopolymers 16 and 18. The base sleeve 12 preferably comprises a thin-walled hollow cylindrical sleeve which comprises a fiber-reinforced polymer resin having a wall thickness of from between about 0.01 and 6.35 mm, and more preferably, between about 0.60 to 0.80 mm. One example of a base sleeve construction which may be used in the present invention is described in commonly-assigned U.S. Pat. No. 6,703,095. The cylindrical base is expandable under the application of fluid pressure and provides a fluid-tight seal when the sleeve is mounted onto a cylinder, mandrel, or the like.

Cushion layer 14 is applied over base sleeve 12 as shown in FIG. 1. Preferably, cushion layer 14 has a thickness of from between about 0.25 mm to 3.25 mm, and more preferably, between about 1.00 to 1.50 mm. The cushion layer may take a number of forms, including an open or closed cell polymeric foam with uniformly distributed microspheres or chemically blown cells, or a volume displaceable material having a low shore hardness. The cushion layer is preferably comprised of polyurethane, styrene-butadiene block copolymers, styrene-isoprene block copolymers, polysiloxanes, and other elastomeric polymers having a glass transition temperature below about −1° C. The cushion layer may be applied as an uncured viscous coating which is then cured, or it may be applied as a pre-cured layer that is wrapped around the sleeve. Preferred processes for making the cushion layer include extrusion, rotary coating, rotary casting, knife coating, or spray coating.

As shown in FIG. 1, a first photopolymer layer 16 is applied over cushion layer 14 to form an integral sleeve. The first photopolymer layer preferably comprises a styrenic block copolymer-based material such as Dupont Cyrel® HORB or MacDermid SP6.0. The first photopolymer layer 16 has a thickness that is preferably equal to or greater than the thickness of the desired floor, and preferably has a thickness of from between about 40% to about 80% of the total sleeve thickness. The thickness is preferably from between about 0.020 inches to 0.120 inches (about 0.05 to 0.30 cm), and more preferably, about 0.035 inches (about 0.09 cm).

The second photopolymer layer 18 is applied over the first photopolymer layer 16. The second photopolymer layer is uncured and may comprise a styrenic block copolymer as described above. It should be appreciated that while in one embodiment the first and second photopolymer layers are comprised of the same material, they may also comprise different materials. The second photopolymer layer preferably has a thickness of from about 20% to about 60% of the total sleeve thickness. The thickness is preferably between about 0.020 inches and 0.075 inches (about 0.05 and 0.19 cm), and more preferably, about 0.025 inches (about 0.06 cm).

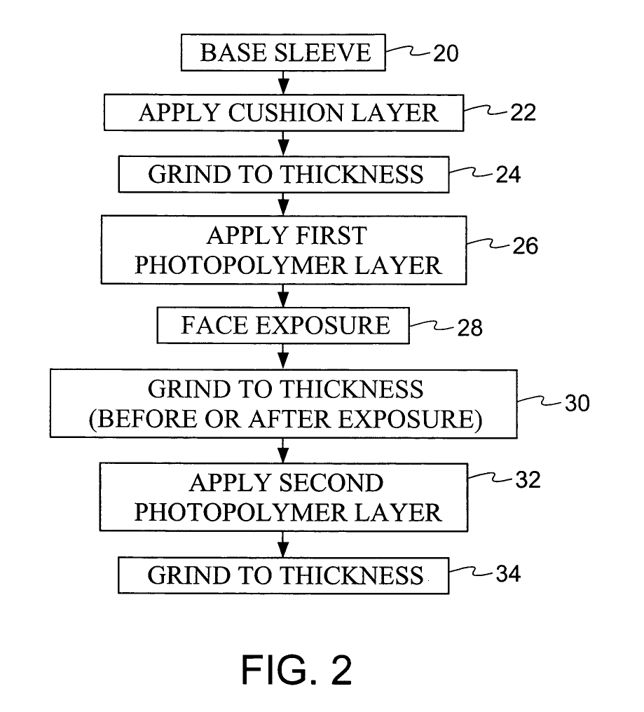

The flowchart of FIG. 2 depicts a general representation of the stages in the production of a photopolymer sleeve blank in accordance with a preferred embodiment of the present invention. A base sleeve is provided (20), and a cushion layer is applied to the base sleeve (22). The cushion layer is preferably coated onto the base sleeve by methods known in the art such as, for example, liquid rotary casting. Alternatively, the cushion could be preformed and then applied in uncured, semi-cured, or cured forms. Once applied, the cushion layer is ground (24) to the desired thickness by methods known in the art such as, for example, stone grinding.

The first photopolymer layer is then applied over the cushion layer (26). The first photopolymer layer is preferably laminated to the cushion layer by applying a thin sealer and/or adhesive promoting agent to the surface of the cushion layer. Such sealants or adhesion promoting agents are known in the art. It should be appreciated that if the surface of the cushion layer is sufficiently smooth after grinding, a sealer or adhesion promoter may not be necessary. However, it is important that the integrity of the bond between the cushion layer and first photopolymer layer be maintained. After lamination, the first photopolymer layer is preferably fused to the surface of the cushion layer by the application of heat in a manner sufficient to partially melt the photopolymer such that any seams flow together and are substantially eliminated. Preferably, the first photopolymer layer and cushion layer are fused by the application of infrared heat.

The first photopolymer layer is then exposed to radiation (28). The source of radiation is preferably a UV light source which is positioned exterior to the base sleeve, to provide “face” exposure. The photopolymer surface is preferably ground to a desired wall thickness (30) so that the floor is precisely established, either before or after exposure to radiation. Preferably, the layer is ground by conventional methods such as stone grinding.

The second photopolymer layer is then applied (32) over the first photopolymer layer, followed by grinding (34) to the final desired thickness and surface finish of the photopolymer. Preferably, the second photopolymer is also fused to the surface of the first photopolymer layer by infrared heat prior to grinding. An optional adhesion promoting agent may be applied to the first photopolymer layer prior to application of the second photopolymer layer.

After grinding, the sleeve is preferably cleaned and coated with a thin layer of an ablatable coating, such as a LAMS coating. This coating blocks UV light from the second photopolymer layer which could polymerize the layer prior to use.

The resulting sleeve comprises a ready-to-image seamless integral sleeve blank which can be imaged and processed in a tubular manner using conventional equipment. The outer surface of the second photopolymer layer of the sleeve may be imaged as is known in the art to provide a raised relief surface or depressions for flexographic printing. For example, the second photopolymer layer may be imaged by actinic radiation, by mechanical grinding, or by laser ablation to form an imaged relief surface. The resulting sleeve provides high print quality.

Having described the invention in detail and by reference to preferred embodiments thereof, it will be apparent that modifications and variations are possible without departing from the scope of the invention.

1. A method of making a photopolymer sleeve blank comprising:
providing a base sleeve having an inner surface and an outer surface;
applying a cushion layer over said outer surface of said base sleeve;
applying a first photopolymer layer over said cushion layer;
exposing an exterior-facing surface of said first photopolymer layer to a curing source; and
applying a second photopolymer layer over said first photopolymer layer.

2. The method of claim 1 wherein said base sleeve comprises a fiber-reinforced polymeric resin.

3. The method of claim 1 wherein said base sleeve has a wall thickness of from between about 0.01 and about 6.35 mm.

4. The method of claim 1 wherein said base sleeve has a wall thickness of from between about 0.60 and about 0.80 mm.

5. The method of claim 1 wherein said first photopolymer layer comprises a styrenic block copolymer-based material.

6. The method of claim 1 wherein said second photopolymer layer comprises a styrenic block copolymer-based material.

7. The method of claim 1 wherein said cushion layer is selected from the group consisting of a closed cell foam, an open cell foam, or a volume displaceable material.

8. The method of claim 1 wherein said cushion layer has a thickness from between about 0.25 mm and about 3.25 mm.

9. The method of claim 1 wherein said cushion layer has a thickness between about 1.00 to about 1.50 mm.

10. The method of claim 1 wherein said cushion layer is applied to said base sleeve as a coating onto the surface of said base sleeve.

11. The method of claim 1 wherein said cushion layer is applied to said base sleeve as a pre-cured layer which is wrapped around said sleeve.

12. The method of claim 1 including grinding the surface of said cushion layer to achieve a predetermined thickness after application of said cushion layer.

13. The method of claim 1 including applying a sealer or adhesive promoting agent to the surface of said cushion layer prior to applying said first photopolymer layer.

14. The method of claim 13 including laminating said first photopolymer layer to said surface of said cushion layer.

15. The method of claim 13 including fusing said first photopolymer layer to said surface of said cushion layer by the application of heat.

16. The method of claim 1 including grinding the surface of said first photopolymer layer to achieve a predetermined thickness prior to exposure to said curing source.

17. The method of claim 1 including grinding the surface of said first photopolymer layer to achieve a predetermined thickness after exposure to said curing source.

18. The method of claim 1 wherein said first photopolymer comprises from about 40% to about 80% of the total sleeve thickness.

19. The method of claim 1 wherein said second photopolymer layer is laminated to said first photopolymer layer.

20. The method of claim 19 including fusing said second photopolymer layer to said first photopolymer layer by the application of heat.

21. The method of claim 20 including grinding the surface of said second photopolymer layer to achieve a predetermined thickness.

22. The method of claim 1 wherein said second photopolymer comprises from about 20% to about 60% of the total sleeve thickness.

23. The method of claim 1 wherein said curing source comprises radiation.

24. The method of claim 21 wherein said radiation curing source comprises a UV light source positioned exterior to said base sleeve.

25. The method of claim 1 including coating said second photopolymer layer with an ablatable coating.

26. The method of claim 1 including forming an image on said sleeve blank.

27. A photopolymer sleeve blank having a seamless surface formed by the method of claim 1.
